(19) United States
(12) Patent Application Publication
(10) Pub. No.: US 2003/0205468 A1
(43) Pub. Date: Nov. 6, 2003

(54) High temperature poison resistant sensor

(76) Inventors: Ming-Cheng Wu, Rochester Hills, MI (US); Eric P Clyde, Bay City, MI (US)

Correspondence Address: Vincent A Cichosz, Delphi Technologies Inc, 1450 West Long Lake Road, Troy, MI, 48007-5052, US

(21) Appl. No.: 10/240,084

(22) PCT Filed: Mar. 28, 2001
(86) PCT No.: PCT/US01/09961

(51) Int. Cl. G01N 27/26

(52) U.S. Cl. 204/428; 29/592.1

(57) ABSTRACT

A sensor and a method for making a sensor is disclosed. The method for making the sensor comprises: mixing a first metal oxide stabilized alumina with alpha alumina in a liquid to create a base slurry, mixing into said base slurry a second metal oxide stabilized alumina and a fugitive material to create a composition; applying said composition to at least a portion of a sensing element comprising two electrodes with an electrolyte disposed therebetween; and calcining said sensing element. One embodiment of the sensor comprises: a sensing element comprising a first electrode and a second electrode having an electrolyte disposed therebetween, wherein a protective layer is disposed in physical contact with a side of said first electrode opposite said electrolyte; and a protective coating disposed over at least a portion of said protective layer on a side of said protective layer opposite said first electrode, said protective coating comprising a milled metal oxide stabilized alumina, an alpha-alumina, an un-milled metal oxide sttabilized alumina

### CROSS-REFERENCE TO RELATED APPLICATION

The present application claims the benefit of the filing date of U.S. Provisional Application No. 60/192,769, filed on Mar. 28, 2000, which is incorporated herein in its entirety.

### BACKGROUND

The automotive industry has used exhaust gas sensors in automotive vehicles for many years to sense the composition of exhaust gases, namely, oxygen. For example, a sensor is used to determine the exhaust gas content for alteration and optimization of the air to fuel ratio for combustion.

One type of sensor uses an ionically conductive solid electrolyte between porous electrodes. For oxygen, solid electrolyte sensors are used to measure oxygen activity differences between an unknown gas sample and a, known gas sample. In the use of a sensor for automotive exhaust, the unknown gas is exhaust and the known gas, (i.e., reference gas), is usually atmospheric air because the oxygen content in air is relatively constant and readily accessible. This type of sensor is based on an electrochemical galvanic cell operating in a potentiometric mode to detect the relative amounts of oxygen present in an automobile engine's exhaust. When opposite surfaces of this galvanic cell are exposed to different oxygen partial pressures, an electromotive force (“emf”) is developed between the electrodes according to the Nernst equation.

With the Nernst principle, chemical energy is converted into electromotive force. A gas sensor based upon this principle typically consists of an ionically conductive solid electrolyte material, a porous electrode with a porous protective overcoat exposed to exhaust gases (“exhaust gas electrode”), and a porous electrode exposed to a known gas' partial pressure (“reference electrode”). Sensors typically used in automotive applications use a yttria stabilized zirconia based electrochemical galvanic cell with porous platinum electrodes, operating in potentiometric mode, to detect the relative amounts of a particular gas, such as oxygen for example, that is present in an automobile engine's exhaust. Also, a typical sensor has a ceramic heater attached to help maintain the sensor's ionic conductivity at low exhaust temperatures. When opposite surfaces of the galvanic cell are exposed to different oxygen partial pressures, an electromotive force is developed between the electrodes on the opposite surfaces of the zirconia wall, according to the Nernst equation:

$$E = ( \frac{- RT}{4 F} ) ln ( \frac{{P}_{{O}_{2}}^{ref}}{{P}_{{O}_{2}}} )$$

where:

E=electromotive force

R=universal gas constant

F=Faraday constant

T=absolute temperature of the gas

P_{O}_{₂}^{ref}=oxygen partial pressure of the reference gas

P_{O}_{₂}=oxygen partial pressure of the exhaust gas

Due to the large difference in oxygen partial pressure between fuel rich and fuel lean exhaust conditions, the electromotive force (emf) changes sharply at the stoichiometric point, giving rise to the characteristic switching behavior of these sensors. Consequently, these potentiometric oxygen sensors indicate qualitatively whether the engine is operating fuel-rich or fuel-lean, conditions without quantifying the actual air-to-fuel ratio of the exhaust mixture.

In a conventional sensor, the sensor comprises a first electrode capable of sensing an exhaust gas and a second electrode capable of sensing a reference gas with an ionically conductive solid electrolyte disposed therebetween. High temperatures can damage the sensor by causing a cracking effect on the protective coating surrounding the sensor. In such an instance, materials such as silicon, lead and the like, present in engine exhaust, can poison or otherwise damage the sensing electrode.

The sensor can also be affected by the formation of an amorphous zinc pyrophosphate glaze, which originates from engine oil additives, such as zinc dialkyldithiophosphate (ZDP). The zinc pyrophosphate glaze can plug the entire coating surface of the oxygen sensor inhibiting performance. In order to prevent poisoning/damage to the sensing electrode, a protective layer made of spinel or the like, has conventionally been applied to the sensing electrode.

The protective layer is designed to allow for the electrodes to sense the particular gas without inhibiting the performance of the sensor. A thick layer (or multiple layers) of protective coating more effectively inhibits the transmission of the poisoning materials, but at the expense of a decrease in the efficiency of the sensor.

### SUMMARY

The drawbacks and disadvantages of the prior art are overcome by the high temperature poison resistant sensor.

A sensor and a method for making a sensor is disclosed. The method for making the sensor comprises: mixing a first metal oxide stabilized alumina with alpha alumina in a liquid to create a base slurry, mixing into said base slurry a second metal oxide stabilized alumina and a fugitive material to create a composition; applying said composition to at least a portion of a sensing element comprising two electrodes with an electrolyte disposed therebetween; and calcining said sensing element.

One embodiment of the sensor comprises: a sensing element comprising a first electrode and a second electrode having an electrolyte disposed therebetween, wherein a protective layer is disposed in physical contact with a side of said first electrode opposite said electrolyte; and a protective coating disposed over at least a portion of said protective layer on a side of said protective layer opposite said first electrode, said protective coating comprising a milled metal oxide stabilized alumina, an alpha-alumina, an un-milled metal oxide stabilized alumina.

The above described and other features are exemplified by the following figures and detailed description.

### BRIEF DESCRIPTION OF THE DRAWINGS

Referring now to the figures, wherein like elements are numbered alike in several figures:

FIG. 1 is an expanded view of one embodiment of an oxygen sensor;

FIG. 2 is a graph showing the pore volume density distribution of an un-stabilized Al₂O₃ slurry versus the calcine temperature;

FIG. 3 is a graph showing the pore volume density distribution of 2 mol. % La₂O₃-stabilized alumina slurry versus the calcine temperature;

FIG. 4 is an optical image of an oxygen sensor element coated with an un-stabilized alumina slurry after annealing to a temperature of 1,200° C. for one hour;

FIG. 5 is an optical image of an oxygen sensor element coated with La₂O₃-stbilized alumina slurry after annealing to a temperature of 1,200° C. for one hour; and

FIG. 6 is a graph showing steady-state engine performance data obtained after a 100-hour siloxane-poisoning test following a 50 hour high temperature exposure for various sensors with normalized air-to-fuel ratio on the X axis (lambda) and sensor output on the Y axis in millivolts (mV).

### DESCRIPTION OF THE PREFERRED EMBODIMENT

A protective coating for sensors, in particular, oxygen sensors, is formed for poison resistance at high temperatures. Specifically, the protective coating herein provides resistance for the sensor at high temperatures against silica poisoning, e.g., that originated from engine gasket seals and/or coolant leaks and zinc-phosphorous poisoning from engine oil additives. The formation of a coating of aluminum oxide depends upon the physical and chemical properties of the alumina slurry, which in turn, is determined by the slurry formation.

Although described in connection with an oxygen sensor, it is to be understood that the protective coating can be employed with any type of sensor, such as nitrogen oxide sensor, hydrogen sensor, hydrocarbon sensor, or the like. Although described in connection with a planar sensor and a conical sensor, it is to be understood that the protective coating can be employed with any type of sensor, such as a wide-range, switch-type, and the like.

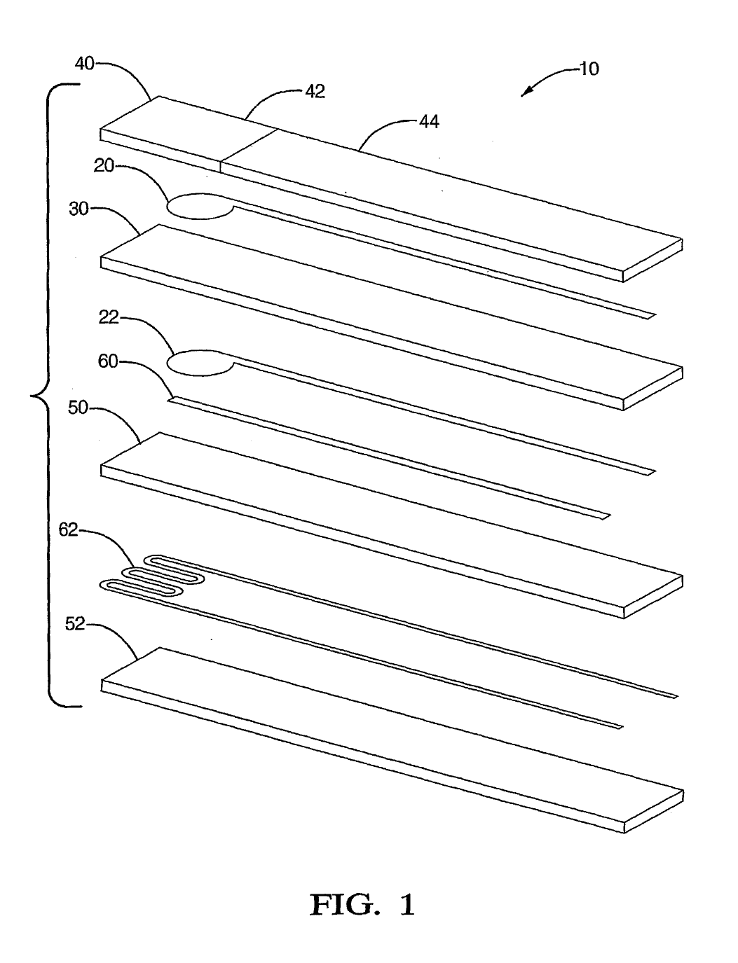

Referring to FIG. 1, the sensor element 10 is illustrated. The exhaust gas (or outer) electrode 20 and the reference gas (or inner) electrode 22 are disposed on opposite sides of, and adjacent to, a solid electrolyte layer 30 creating an electrochemical cell (20/30/22). On the side of the exhaust gas electrode 20, opposite solid electrolyte 30, can be a protective layer 40, having a dense section 44 and a porous section 42, that enables fluid communication between the exhaust gas electrode 20 and the exhaust gas. Meanwhile, disposed on the side of the reference electrode 22, opposite solid electrolyte 30, can be an optional reference gas channel 60, which is in fluid communication with the reference electrode 22 and optionally with the ambient atmosphere and/or the exhaust gas. Disposed on a side of the reference gas channel 60, opposite the reference electrode 22, can be a heater 62 for maintaining sensor element 10 at the desired operating temperature. Typically disposed between the reference gas channel 60 and the heater 62, as well as on a side of the heater opposite the reference gas channel 60, are one or more insulating layers 50, 52.

In addition to the above sensor components, conventional components can be employed, including but not limited to, lead gettering layer(s), leads, contact pads, ground plane(s), support layer(s), additional electrochemical cell(s), and the like. The leads, which supply current to the heater and electrodes, are typically formed on the same layer as the heater/electrode to which they are in electrical communication and extend from the heater/electrode to the terminal end of the gas sensor where they are in electrical communication with the corresponding via (not shown) and appropriate contact pads (not shown).

Insulating layers 50, 52, and protective layer 40, provide structural integrity (e.g., protect various portions of the gas sensor from abrasion and/or vibration, and the like, and provide physical strength to the sensor), and physically separate and electrically isolate various components. The insulating layer(s), which can be formed using ceramic tape casting methods or other methods such as plasma spray deposition techniques, screen printing, stenciling and others conventionally used in the art, can each be up to about 200 microns (μm) thick or so, with a thickness of about 50 μm to about 200 μm preferred. Since the materials employed in the manufacture of gas sensors preferably comprise substantially similar coefficients of thermal expansion, shrinkage characteristics, and chemical compatibility in order to minimize, if not eliminate, delamination and other processing problems, the particular material, alloy or mixture chosen for the insulating and protective layers is dependent upon the specific electrolyte employed. Typically, the insulating layers 50, 52 comprise a dielectric material such as alumina, and the like, while the protective layer 40 can comprise alumina, spinel, and the like.

Disposed between the insulating layers 50, 52, is a heater 62 that is employed to maintain the sensor element at the desired operating temperature. Heater 62 can be any conventional heater capable of maintaining the sensor end at a sufficient temperature to facilitate the various electrochemical reactions therein. The heater 62, which is typically platinum, aluminum, palladium, and the like, as well as mixtures, oxides, and alloys comprising at least one of the foregoing metals, or any other heater, is generally screen printed or otherwise disposed onto a substrate to a thickness of about 5 μm to about 50 μm.

The heater 62 maintains the electrochemical cell (electrodes 20, 22 and electrolyte 30) at a desired operating temperature. The electrolyte layer 30 can be solid or porous, can comprise the entire layer or a portion thereof, can be any material that is capable of permitting the electrochemical transfer of oxygen ions, should have an ionic/total conductivity ratio of approximately unity, and should be compatible with the environment in which the gas sensor will be utilized (e.g., up to about 1,200° C.). Possible electrolyte materials can comprise any material employed as sensor electrolytes, including, but not limited to, zirconia, and the like, which may optionally be stabilized with calcium, barium, yttrium, magnesium, aluminum, lanthanum, cesium, gadolinium, and the like, as well as oxides, alloys, and combinations comprising at least one of the foregoing materials. For example, the electrolyte can be alumina and/or yttrium stabilized zirconia Typically, the electrolyte, which can be formed via many conventional processes (e.g., die pressing, roll compaction, stenciling and screen printing, tape casting techniques, and the like), has a thickness of up to about 500 μm or so, with a thickness of about 25 μm to about 500 μm preferred, and a thickness of about 50 μm to about 200 μm especially preferred.

It should be noted that the electrolyte layer 30 and porous section 42 can comprise an entire layer or a portion thereof; e.g., they can form the layer, be attached to the layer (porous section/electrolyte abutting dielectric material), or disposed in an opening in the layer (porous section/electrolyte can be an insert in an opening in a dielectric material layer). The latter arrangement eliminates the use of excess electrolyte and protective material, and reduces the size of gas sensor by eliminating layers. Any shape can be used for the electrolyte and porous section, with the size and geometry of the various inserts, and therefore the corresponding openings, being dependent upon the desired size and geometry of the adjacent electrodes. It is preferred that the openings, inserts, and electrodes have a substantially compatible geometry such that sufficient exhaust gas access to the electrode(s) is enabled and sufficient ionic transfer through the electrolyte is established.

The electrodes 20, 22, are disposed in ionic contact with the electrolyte layer 30. These electrodes can comprise any catalyst capable of ionizing oxygen, including, but not limited to, platinum, palladium, osmium, rhodium, iridium, gold, ruthenium, zirconium, yttrium, cerium, calcium, aluminum, silicon, and the like, and oxides, mixtures, and alloys comprising at least one of the foregoing catalysts. As with the electrolyte, the electrodes 20, 22 can be formed using numerous techniques, including sputtering, painting, chemical vapor deposition, screen printing, spraying, and stenciling, among others. If a co-firing process is employed for the formation of the sensor, screen printing the electrodes onto appropriate tapes is preferred due to simplicity, economy, and compatibility with the co-fired process. Electrode leads and vias (not shown) in the insulating and/or electrolyte layers are typically formed simultaneously with electrodes.

An alternative sensor design can include a conical sensor. The conical sensor typically comprises an electrolyte body, having an inner surface, an outer surface, and a cavity opening and a cavity terminus located at opposing ends of electrolyte body. An inner electrode is disposed on the inner surface, and an outer electrode is disposed on outer surface. A protective layer 40 can be applied to the outer electrode to provide structural integrity and minimal poison protection. The conical sensor can be formed in any generally cylindrical shape and is preferably tapered from the cavity opening to the cavity terminus. A protrusion is typically formed on the sensor element at a point between the cavity opening and the cavity terminus to define an upper shoulder and a lower shoulder that preferably extends completely around the circumference of a cross-section of the electrolyte. The protrusion is generally configured and dimensioned to engage a surface within a shell portion of the gas sensing apparatus into which the sensor element is received, thereby causing the inactive portion of the sensor, e.g., the portion above and including the lower shoulder, to extend out of the shell portion while the active portion extends into the shell portion to contact the exhaust gas. The materials, as indicated above for the planar sensor, can also be utilized with the conical sensor.

Following the formation of the sensing element 10, a protective coating can be applied to the sensing element 10. This protective coating may optionally be used to coat the entire sensing element 10 or a portion of the sensing element 10 (e.g., all or part of the protective layer 40). The coating can be applied to the sensing element 10 by a variety of techniques, including immersion, screen printing, stenciling, spraying, and the like. The coating preferably comprises high surface area (e.g., about 100 m²/g or greater) alumina (e.g., theta-alumina (θ-Al₂O₃), gamma-alumina (γ-Al₂O₃), delta-alumina (δ-Al₂O₃), and combinations comprising at least one of the foregoing aluminas), stabilized by rare earth or alkaline earth metal oxides, such as lanthanum oxide (La₂O₃), strontium oxide (SrO), barium oxide (BaO), calcium oxide (CaO), and combinations comprising at least one of the foregoing metal oxides. Some alkali metal oxides (e.g. potassium oxide, and the like), as well as transition metal oxides (e.g., zirconium oxide, and the like), also may be suitable as the stabilizer. A θ-Al₂O₃ stabilized with La₂O₃ is preferred. The lanthanide/alkaline earth elements with large ionic radii of about 0.11 nanometers (nm) or greater, with a radii of about 0.11 nm to about 0.15 nm preferred, were found to be most effective in stabilizing porous structures of alumia high temperature. For example, the rare earth and/or alkaline earth metal in the alumina can be present at greater than about 1.5 weight percent (wt. %), with greater than about 2.5 wt. % preferred, based upon the total weight of the stabilized alumina. The rare earth and/or alkaline earth metal in the alumina can be present in the total composition at less than about 6.0 wt. %, with less than about 3.5 wt. %, preferred.

The stabilized alumina may be made by impregnation of rare earth or alkaline earth metal nitrates or their chlorides, or by other methods. For example, a stabilized aluminum oxide can be prepared by measuring the water uptake by dry θ-Al₂O₃ powders. An amount of nitrates or chlorides is weighed and added to double de-ionized water, water, solvent, and the like. The resulting solution is sprayed onto the alumina powders to ensure that all of the solid particles are uniformly soaked. The wetted powders are allowed to dry overnight. Prior to use for forming the base slurry, the stabilized alumina is calcined to about 800° C. for about 2 hours. This calcination transforms the nitrates into corresponding oxides.

When forming the protective coating, a base slurry is prepared. The base slurry comprises a high surface alumina, a fine (e.g., about 10 μm or less in diameter, with about 0.5 μm or less in diameter preferred) alpha-alumina (α-Al₂O₃), and a binder. Un-milled high surface area alumina and a fugitive material are then added into the base slurry, creating a final slurry.

To create the base slurry, a high-surface area alumina, such as θ-Al₂O₃, is stabilized with La₂O₃, SrO, BaO, potassium oxide, and/or zirconium oxide, and is mixed with a fine α-Al₂O₃ and a binder, such as aluminum nitrate (Al(NO₃)₃). The high surface area alumina preferably has an average particle size of about 20 μm or more in diameter, with about 40 μm to about 50 μm in diameter preferred.

The stabilized θ-Al₂O₃ can be present in the base slurry in amounts of greater than about 10 wt. % of the total solid composition of the base slurry, with greater than about 30 wt. % preferred, and greater than about 45 wt. % more preferred. Preferably, the stabilized θ-Al₂O₃ is present in an amount of less than about 90 wt. %, with less than about 70 wt. % more preferred, and less than about 55 wt. % even more preferred. The α-Al₂O₃ can be present in the base slurry in amounts of greater than about 10 wt. % of the total solid composition thereof, with greater than about 30 wt. % preferred, and greater than about 45 wt. % more preferred. Preferably, the α-Al₂O₃ is present in an amount of less than about 90 wt. %, with less than about 70 wt. % preferred, and less than about 55 wt. % more preferred. The binder can be present in the base slurry in amounts of greater than about 1 wt. % of the total solid composition thereof, with greater than about 2 wt. % preferred. Preferably, the binder is present in an amount of less than about 10 wt. %, with less than about 6 wt. % preferred. For example, a slurry can be formed of La₂O₃-stabilized alumina with about 48 wt. % of La₂O₃ stabilized θ-Al₂O₃, about 48 wt. % of α-Al₂O₃, and about 4 wt. % of Al(NO₃)₃. The percentage of solids present in the slurryin amounts of greater than about 30 wt. % of the total composition, with greater than about 45 wt. % preferred, and greater than about 48 wt. % more preferred. Preferably, the percentage of solids present in the slurry is an amount of less than about 70 wt. %, with less than about 55 wt. % preferred, and less than about 52 wt. % more preferred.

The base slurry is stirred thoroughly prior to being milled. The base slurry is then milled (e.g., using a vibro-energy grinding mill) for about 2 hours, or so, to break down the aggregates of the high surface area alumina (e.g., θ-Al₂O₃). During milling, the average size of the θ-Al₂O₃ aggregates, decreases from a size of less than about 20 microns (μ) or less to preferably about 5 microns (μm) or less, with about 1 μm or less more preferred.

The characteristics of the base slurry were also determined. The pH of the base slurry is preferably controlled to attain the desired viscosity. The pH of the slurry has a direct relationship with the viscosity of the slurry, such that the more acidic the slurry the greater the viscosity of the slurry. Consequently, a pH of less than about 4.0 is generally employed, with a pH of less than about 3.6 preferred, and less than about 3.4, more preferred. A pH of greater than about 3.1 is preferred, with a pH of greater than about 3.3 more preferred.

Preferably, the viscosity of this base slurry at a spindle speed of about 12 revolutions per minute (rpm) is greater than about 720 centipoises (cps), with less than about 830 cps preferred. The viscosity of this base slurry at a spindle speed of about 30 rpm is greater than about 355 cps, with less than about 410 cps preferred. The viscosity of this base slurry at a spindle speed of about 60 rpm is greater than about 210 cps, with less than about 270 cps preferred.

Measurements of the physical properties of both an un-stabilized alumina (Al₂O₃) base slurry and a La₂O₃-stabilized alumina base slurry were completed, and are illustrated in Table 1. The formula for the un-stabilized alumina slurry was about 49 wt. % of θ-Al₂O₃, about 49 wt. % of α-Al₂O₃, and about 2 wt. % of Al(NO₃)₃, while the formula for the La₂O₃-stabilized alumina slurry was about 48 wt. % of La₂O₃ stabilized θ-Al₂O₃, about 48 wt. % of α-Al₂O₃, and about 4 wt. % of Al(NO₃)₃.

TABLE 1

| | Relative XRD | | BET Surface |
|---|---|---|---|
| | Intensity of α vs. θ | BET Surface Area | Area of |
| Calcine | phases of Un- | of Un-stabilized | 2 mol. % |
| Temperature | stabilized Al₂O₃ | Al₂O₃ slurry | La₂O₃/Al₂O₃ |
| (° C.) | slurry | (m²/g) | slurry (m²/g) |
| 500 | 72/28 | 50.8 | 58.7 |
| 800 | 66/34 | 42.2 | 50.6 |
| 900 | 70/30 | 38.2 | — |
| 1000 | 89/11 | 23.8 | 43.1 |
| 1100 | 100/0 | 5.8 | 30.6 |

The following steps were taken to prepare the sample for X-ray diffraction (XRD) and Brunauer-Emmet-Teller (BET) surface area measurements. Each sample of un-stabilized alumina slurry and La₂O₃-stabilized alumina slurry was dried at about 90° C. and then ground into fine powders. The powders were calcined for about two hours at a temperature of about 500° C. to about 1,100° C. to simulate the range of exhaust temperatures in an automobile engine.

For the unstablized alumina, relative intensity of the α-Al₂O₃ phase versus the θ-Al₂O₃ phase in XRD spectra increases at about 1,000° C. and the θ-Al₂O₃ phase converts to the α-Al₂O₃ phase at a temperature of about 1,100° C. The structural transformation to the α-Al₂O₃ phase is further evident in the BET surface area measurements. The surface area of the un-stabilized alumina slurry powders decreases at temperatures above about 900° C. and down to a value of about 5.8 m²/g at 1,100° C. In contrast to the un-stabilized alumina slurry, the La₂O₃-stabilized alumina slurry retains about 52% (about 30.6 m²/g) of its original surface area of about 58.7 m²/g after calcining for about two hours at about 1,100° C.

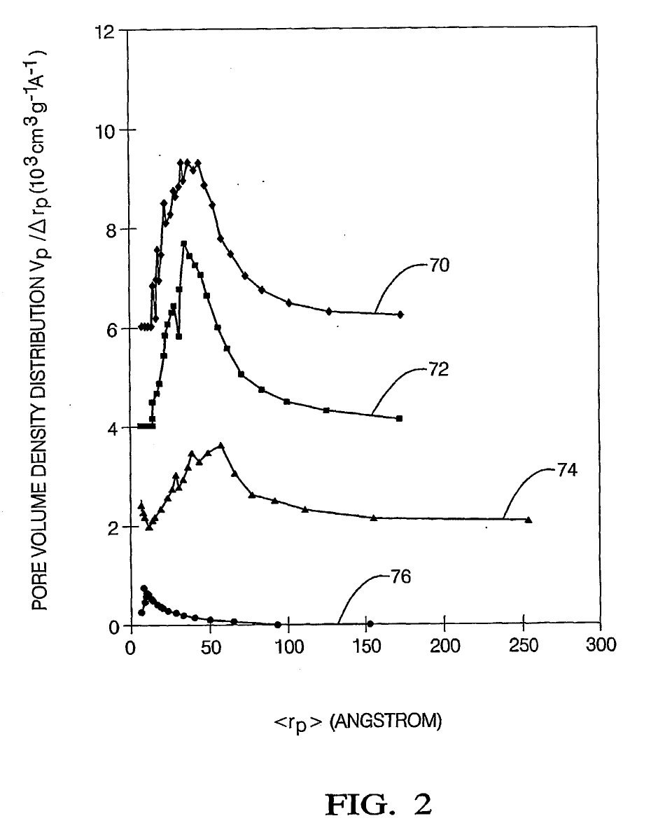

The structural transformation of the un-stabilized alumina slurry is illustrated in FIG. 2 at temperatures of about 500° C., about 700° C., about 1,000° C., and about 1,100 20 C., represented by lines 70, 72, 74, and 76, respectively. The pore volume density distribution is greater at lower temperatures (i.e., 500° C., line 70). The pore volume reduction was observed at 1,000° C., line 74 and the pores were eliminated at 1,100° C., line 76.

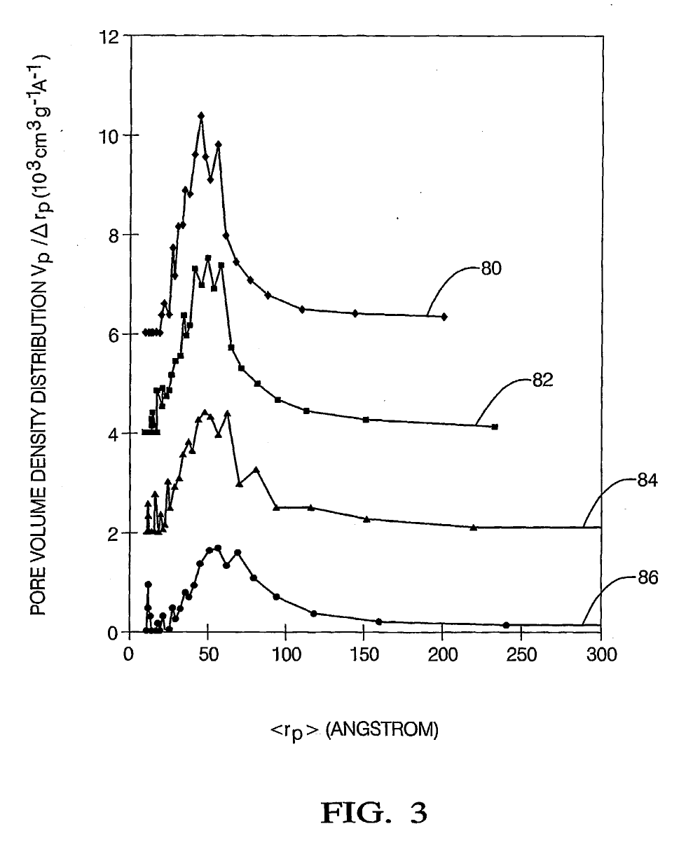

In contrast to FIG. 2, FIG. 3 illustrates that a significant amount of pores still exist for the La₂O₃-stabilized alumina slurry even after exposure to a temperature of about 1,100° C. for about two hours (line 86). The graph illustrates the pore volume density distribution at temperatures of about 500° C., about 800° C., about 1,000° C., and about 1,100° C., represented by lines 80, 82, 84, and 86, respectively. The maximum in pore volume density distribution at 1,100° C., line 86 is slightly shifted from 45 angstroms (A) to about 60 A (in radius) when the calcine temperature increases from about 500° C., line 80 to about 1,100° C., line 86. Therefore, at high temperatures using this La₂O₃-stabilized alumina slurry as a protective coating, a significant amount of pores still exist.

Following the milling of the base slurry, un-milled stabilized alumina and a fugitive material are added to the base slurry to form the final slurry. The un-milled stabilized alumina is mixed into the base slurry to obtain low-density “fluffy” alumina slurry. The un-milled stabilized alumina is present in the final slurry in an amount of about 25 wt. % or greater, based on the total weight of the solids of the final slurry (excluding the fugitive material), with greater than about 30 wt. % preferred. Preferably, less than about 40 wt. %, with less than about 35 wt. % preferred, of the un-milled stabilized alumina is mixed into the base slurry.

The fugitive material, such as carbon (e.g., carbon black, and the like) or other appropriate substitute, added to the base slurry further decreases the density of the calcined protective coating. As used herein, a “fugitive material” means a material that will occupy space until the coating is calcined, thus leaving additional porosity in the coating. The fugitive material is present in an amount of greater than about 3 wt. %, based upon the total weight of the solids of the final slurry (excluding the fugitive material), with greater than about 5 wt. % preferred. Preferably, the fugitive material is present in an amount of less than about 15 wt. %, with less than about 10 wt. % preferred. The addition of the fugitive material to the base slurry has a tendency to improve the suspension of the solid particles in the slurry. With the addition of the un-milled stabilized alumina, the viscosity of this final slurry increases to about 8,000 cps at a spindle speed of about 12 rpm, about 4,240 cps at a spindle speed of about 30 rpm, and about 2,870 cps at a spindle speed of about 60 rpm.

The final slurry comprises, based upon the total weight of solids in the final slurry (excluding fugitive material), greater than about 7 wt. % of milled metal oxide stabilized alumina and alpha alumina, each indivdually, with greater than about 20 wt. % preferred, and greater than about 29 wt. % more preferred, with the milled metal oxide stabilized alumina and alpha alumina, each individually, preferably present in amounts of less than about 63 wt. %, with less than about 40 wt. % more preferred, and with less than 39 wt. % even more preferred; greater than about 25 wt. % of un-milled stabilized alumina, with greater than about 30 wt. % preferred, with the un-milled stabilized alumina preferably present in an amount of less than about 40 wt. %, with less than about 35 wt. % more preferred; greater than about 0.7 wt. % binder, with greater than about 1.4 wt. % preferred, with the binder preferably present in an amount of less than about 7 wt. %, with less than about 4.2 wt. % more preferred; and greater than about 3 wt. % fugitive material, with greater than about 5 wt. % preferred, with the fugitive material preferably present in an amount of less than about 15 wt. %, with less than about 10 wt. % more preferred. Following calcination, besides the absence of fugitive material, the composition of the protective coating falls within the ranges listed above.

Finally, in relation to the solvent, the final slurry comprises greater than about 38 wt. % solids, with greater than about 54 wt. % preferred, and greater than about 57 wt. % more preferred, based upon the total weight of the final slurry, with less than about 78 wt. % solids preferred, less than about 65 wt. % more preferred, and less than 63 wt. % even more preferred.

The final slurry can then be applied as a protective coating to at least a portion of the sensing element 10. For example, the sensing element 10 can be immersed in the slurry, which is preferably stirred at a constant speed and then withdrawn from the slurry. The amount of coating deposited on the sensing element depends upon the physical and chemical properties of the slurry, such as viscosity and pH, as well as the withdrawal rate. For example, using a conical oxygen sensor element, about 150 milligrams (mg) to about 350 mg of protective coating adhered to the element (via wet pickup) by manipulating the withdrawal rate. The protective coating created was uniform and crack-free. About 200 mg to about 300 mg of wet pickup (or about 120 mg to about 190 mg of calcined pickup) is preferred.

Following coating deposition, the sensing element is optionally dried at temperatures up to about 100° C. Next, the element can be calcined at a temperature sufficient to bum off the fugitive material, such as about 550° C. to about 800° C., with about 600° C. to about 650° C. preferred, for up to about 2 hours or so, prior to assembly into the sensor. During calcinations, the oven ramp rate should not exceed about 10° C./minute, with about 5° C./minute preferred, at temperatures below about 400° C., in order to produce crack-free coatings.

The desired thickness of the protective coating is based upon the ability to filter out poisoning particulates while allowing passage of the exhaust gases to be sensed. Although a multi-layered coating can be employed, the protective coating is preferably a single layer having an overall thickness of less than about 300 μm, with less than about 200 μm preferred. Preferably, a thickness of greater than about 120 μm is employed.

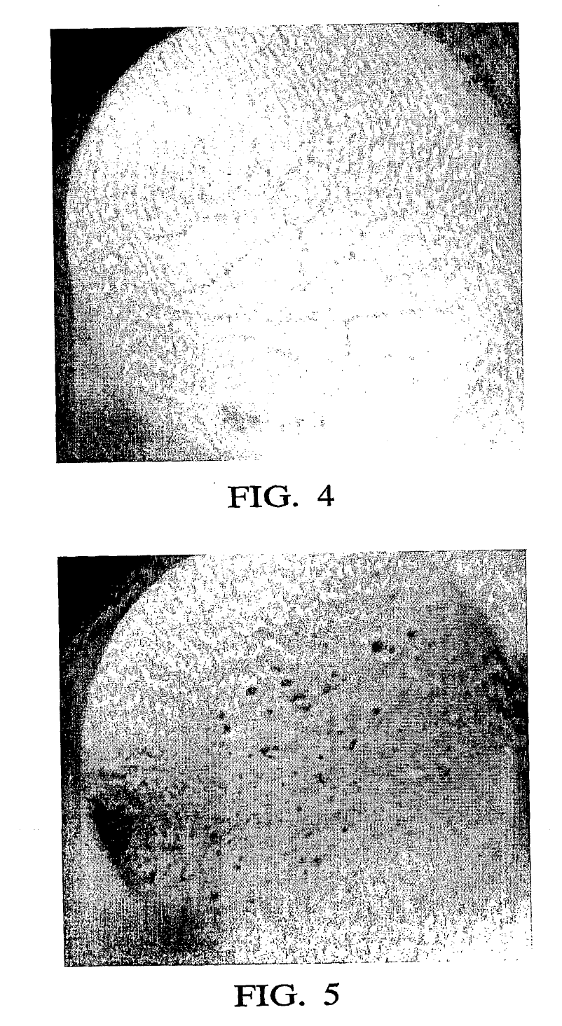

FIG. 4 illustrates an image of a conical sensor element, using an optical microscope (a multiply factor of 22), coated with un-stabilized alumina slurry after annealing to a temperature of about 1,200° C. for about one hour. FIG. 5 illustrates an image of a conical sensor element, using an optical microscope (a multiply factor of 22), coated with a La₂O₃-stabilized alumina slurry after annealing to a temperature of about 1,200° C. for about one hour. As illustrated in FIGS. 4 and 5, respectively, extensive cracks are located in the sensor comprising the un-stabilized alumina coating, whereas no cracks are visible in the sensor comprising the La₂O₃-stabilized alumina coating. This illustrates that the La₂O₃-stabilized alumina coating is resistant to high temperatures.

An experiment was completed with an oxygen sensor, having a La₂O₃-stabilized alumina coating, in a working engine. In this experiment, a La₂O₃-stabilized alumina coating was prepared with the addition of un-milled, coarse La₂O₃-stabilized alumina and carbon black into the base slurry. The sensor was subjected to a 100-hour siloxane poisoning test, which simulates situations where silica-containing engine coolant leakage or degas of engine gasket seal (containing silica) may occur. Prior to the siloxane poisoning test, the sensor was exposed to high temperature exhaust, having a peak temperature of about 930° C. for about 50 hours.

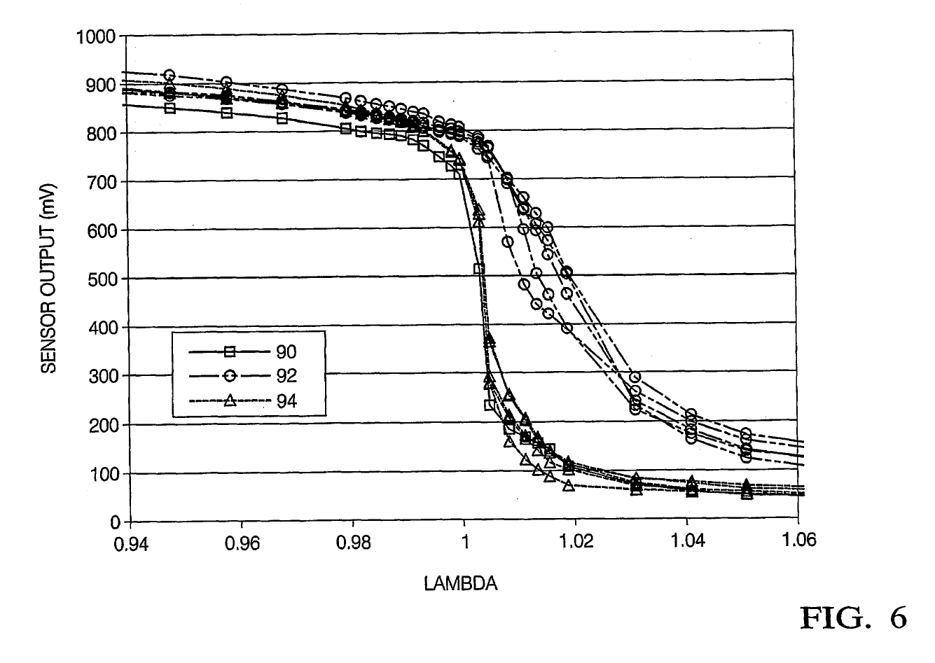

FIG. 6 illustrates steady-state engine performance data (called s-curves) obtained from oxygen sensor parts coated with the La₂O₃-stabilized alumina coating (line 90) and un-stabilized alumina coating (line 92). The s-curve from a reference conical sensor (line 94), having an un-stabilized alumina coating, also is included for comparison. The reference sensor was not subjected to siloxane poisoning and high temperature exposure. The results indicate that all of the oxygen sensor parts coated with the La₂O₃-stabilized alumina coating passed 100 hours of siloxane poisoning following the 50 hour high temperature exposure without noticeable performance degradation. However, a severe lean shift of the switch point in the lambda (the normalized air-to-fuel ratio) was observed for the oxygen sensor parts coated with the un-stabilized alumina coating, as shown in FIG. 6. Furthermore, a detailed engine performance study, conducted at 0, 10, 25, 50, 75, and 100 hours of siloxane poisoning tests following the 50 hour high temperature exposure, revealed that the oxygen sensor parts coated with the un-stabilized alumina coating were “dead” at poisoning hours as early as 50 hours. However, the oxygen sensor parts coated with the La₂O₃-stabilized alumina coating showed no performance degradation at these siloxane-poisoning hours.

As shown above, the oxygen sensor with the stabilized alumina coating withstood the high temperature environment, while the oxygen sensor comprising un-stabilized alumina coating failed because of the presence of cracks. The cracks can cause the sensor to be damaged by the effect of the high temperature environment and/or poisoned by the materials, such as silicon, or ZDP, in the exhaust environment. The use of the high temperature poison resistant exhaust oxygen sensor improves resistance of the exhaust oxygen sensor at high temperatures. This produces a sensor that is cost effective, more durable, and better able to resist the high temperatures present in automobile engines. Unlike the unstablized alumina protective coating, the stabilized alumina protective coating retained greater than about 30% of its initial surface area, with greater than about 40% preferred, greater than about 50% common in temperatures up to about 1,100° C. for about 2 hours. In other words, surface areas of greater than about 10 m²/g were maintained, with greater than about 20 m²/g preferred, and greater than about 30 m²/g common.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for making a sensor, comprising:
mixing a binder and a first metal oxide stabilized alumina with alpha alumina in a liquid to create a base slurry, mixing into said base slurry a second metal oxide stabilized alumina and a fugitive material to create a composition;
applying said composition to at least a portion of a sensing element comprising two electrodes with an electrolyte disposed therebetween; and
calcining said sensing element.

2. The method of claim 1, wherein said metal oxide is selected from the group consisting of rare earth metal oxides, alkali metal oxides, alkaline earth metal oxides, transition metal oxides, and combinations comprising at least one of the foregoing metal oxides.

3. The method of claim 2, wherein said metal oxide is selected from the group consisting of lanthanum oxide, strontium oxide, barium oxide, zirconium oxide, potassium oxide, calcium oxide, and combinations comprising at least one of the foregoing metal oxides.

4. The method of claim 1, wherein said first metal oxide stabilized alumina and said second metal oxide stabilized alumina is La₂O₃-stabilized alumina.

5. The method of claim 1, wherein said first metal oxide stabilized alumina and said second metal oxide stabilized alumina comprises a third alumina selected from the group consisting of theta-alumina, gamma-alumina, delta-alumina, and combinations comprising at least one of the foregoing aluminas.

6. The method of claim 1, further comprising milling said base slurry prior to mixing said base slur with said second metal oxide stabilized alumina.

7. The method of claim 1, wherein said second metal oxide stabilized alumina is un-milled metal oxide stabilized alumina.

8. The method of claim 1, wherein said protective coating has a thickness of up to about 300 μm.

9. The method of claim 8, wherein said protective coating has a thickness of about 120 μm to about 200 μm.

10. A sensor created according to the method of claim 1.

11. A method for making a sensor, comprising:
mixing a binder and first metal oxide stabilized alumina with alpha alumina to create a base slurry, wherein said first metal oxide stabilized alumina is selected from the group consisting of theta-alumina, gamma-alumina, delta-alumina, and combinations comprising at least one of the foregoing aluminas;
milling said base slurry;
mixing into said milled base slurry a second metal oxide stabilized alumina and a fugitive material to create a final slurry, wherein said third alumina is selected from the group consisting of theta-alumina, gamma-alumina, delta-alumina, and combinations comprising at least one of the foregoing aluminas;
applying said composition to at least a portion of a protective layer of a sensing element comprising two electrodes with an electrolyte disposed therebetween; and
calcining said sensing element to form a protective coating.

12. The method of claim 11, wherein said metal oxide is selected from the group consisting of rare earth metal oxides, alkaline earth metal oxides, alkali metal oxide, transition metal oxides, and combinations comprising at least one of the foregoing metal oxides.

13. The method of claim 12, wherein said metal oxide is selected from the group consisting of lanthanum oxide, strontium oxide, barium oxide, zirconium oxide, potassium oxide, calcium oxide, and combinations comprising at least one of the foregoing metal oxides.

14. The method of claim 11, wherein said protective coating has a thickness of up to about 300 μm.

15. The method of claim 14, wherein said protective coating has a thickness of about 120 μm to about 200 μm.

16. A sensor, comprising:
a sensing element comprising a first electrode and a second electrode having an electrolyte disposed therebetween, wherein a protective layer is disposed in physical contact with a side of said first electrode opposite said electrolyte; and
a protective coating disposed over at least a portion of said protective layer on a side of said protective layer opposite said first electrode, said protective coating comprising a milled metal oxide stabilized alumina, an alpha-alumina, an un-milled metal oxide stabilized alumina.

17. The sensor of claim 16, wherein said metal oxide is selected from the group consisting of rare earth metal oxides, alkaline earth metal oxides, alkali metal oxides, transition metal oxides, and combinations comprising at least one of the foregoing metal oxides.

18. The sensor of claim 17, wherein said metal oxide is selected from the group consisting of lanthanum oxide, strontium oxide, barium oxide, zirconium oxide, potassium oxide, calcium oxide, and combinations comprising at least one of the foregoing metal oxides.

19. The sensor of claim 16, wherein said unmilled metal oxide stabilized alumina and said milled metal oxide stabilized alumina is La₂O₃-stabilized alumina.

20. The sensor of claim 16, wherein said unmilled metal oxide stabilized alumina and said milled metal oxide stabilized alumina comprise a third alumina selected from the group consisting of theta-alumina, gamma-alumina, delta-alumina, and combinations comprising at least one of the foregoing aluminas.

21. The sensor of claim 16, wherein said protective coating further comprises about 7 wt % to about 63 wt % of said milled metal oxide stabilized alumina, about 7 wt % to about 63 wt % of said alpha alumina, and about 25 wt % to about 40 wt % un-milled metal oxide stabilized alumina, based upon the total weight of said protective coating.

22. The sensor of claim 21, wherein said protective coating further comprises about 20 wt % to about 40 wt % of said milled metal oxide stabilized alumina, about 20 wt % to about 40 wt % of said alpha alumina, and about 30 wt % to about 35 wt % un-milled metal oxide stabilized alumina, based upon the total weight of said protective coating.

23. The sensor of claim 22, wherein said protective coating further comprises about 29 wt % to about 39 wt % of said milled metal oxide stabilized alumina, and about 29 wt % to about 39 wt % of said alpha alumina.
